(19) United States
(12) Patent Application Publication
(10) Pub. No.: US 2001/0028359 A1
(43) Pub. Date: Oct. 11, 2001

(54) Test support apparatus and test support method for GUI system program

(76) Inventors: Makoto Muraishi, Kawasaki (JP); Masaki Tonomura, Kawasaki (JP); Yasuyuki Fujikawa, Kawasaki (JP)

Correspondence Address: STAAS & HALSEY LLP, 700 11TH STREET, NW, SUITE 500, WASHINGTON, DC, 20001, US

(21) Appl. No.: 09/804,268

(22) Filed: Mar. 13, 2001

(30) Foreign Application Priority Data
Apr. 11, 2000 (JP) 2000-109416

(51) Int. Cl. G06F 9/00

(52) U.S. Cl. 345/700; 345/704

(57) ABSTRACT

An apparatus includes a unit for receiving the screen definition information as input about a test target screen program, and generating a test support class which is a subclass inheriting object-oriented programming for a class on the test target screen program, and tests a screen program, and a unit for conducting a test of the test target screen program using the generated test support class. Thus, a test of a screen program using a graphic user interface can be automatically and efficiently conducted.

### BACKGROUND OF THE INVENTION

1. Field of the Invention

The present invention relates to a program test system, and more specifically to an apparatus and a method for supporting a test conducted on a GUI system program for efficiently and automatically performing a testing operation on a screen program which uses a graphic user interface.

2. Description of the Related Art

When a test is conducted on a screen program which uses a graphic user interface (GUI), it is difficult to generate a testing driver which is normally used in a common program test. Therefore, the test has been individually conducted by a programmer. Generally, there are such test support tools as script (express in writing) the operations of a keyboard and a mouse, but these test support tools may not be used when the position of the screen or the position of the parts on the screen changes.

In a unit test of a screen program, it has been rare that a test is conducted after generating a test specification, but a programmer of a screen program or a person who is in charge of a unit test normally generates an appropriate pattern to conduct a test on a program, thereby causing a problem with the guarantee of a product. Furthermore, although a test is conducted after generating a test specification, the specification is normally generated through visual reference to the definition of a screen. For example, a wrong maximum or minimum value can be obtained, or test data can be mistakenly generated.

Although data is input according to a specification when a test is conducted, the data can be mistakenly input by a person. When input data is not stored, it cannot be verified after the execution of the test. Furthermore, since determination is frequently made as to whether or not the process performed on the input data has been performed through normal steps on the screen program, whether or not the process has been performed through an abnormal process such as an error, etc., it has been difficult to correctly grasp the progress of the screen program when a test is conducted.

A screen program normally has a number of entries. Since one entry has a wide variable range, a test pattern generally grows large, and the entire pattern cannot be manually used. In addition, when a test is conducted again, the input data for the previous test is not stored. Therefore, the same operation is inefficiently repeated. In a marketed test support tool for recording and scripting the operations of a mouse cursor and a keyboard, the tool cannot be used if the position of the screen or the arrangement of the screen parts is changed. Furthermore, is the arrangement of the screen parts is changed, the tool cannot be used when the test is conducted again.

When the performance of a program is measured, that is, when an activating time of a screen is measured, a response time is measured after a button is pressed on the screen, etc., a person in charge normally measures the time using a stopwatch, etc., and it is normally necessary to aggregate data by measuring a time plural times, thereby giving a heavy load on the person in charge. Although it is possible to amend a screen program for a test and display the processing time on the screen, it is necessary in this case to restore the amended portion to the original status after a measuring process, and it is necessary to change the program source after conducting the test, thereby causing uncertain quality of a program by a probable mis-amendment after the completion of the test. Furthermore, when a test report is presented after the test is conducted, a wrong entry can be added by a person in charge of the test because entries are manually added.

### SUMMARY OF THE INVENTION

The present invention aims at providing an apparatus and a method for supporting a test conducted on a GUI system program for efficiently and automatically performing a testing operation on a screen program which uses a graphic user interface, and solving various problems caused in the three steps of the testing operations, that is, generating a test specification, conducting a test, and generating a test report.

To attain the above mentioned purposes, according to an aspect of the present invention, the test support apparatus for supporting a test of a screen program executed using a graphic user interface includes a test support class generation unit and a test execution unit. The test support class generation unit obtains the screen definition information of a program to be tested, and generates a test support class which is a subclass of a test target screen program class, and a class for testing the test target screen program. The test execution unit conducts a test of the test target screen program using the test support class generated by the test support class generation unit. With the configuration, the above mentioned problem can be solved.

With the above mentioned configuration, the test support apparatus can also include a test specification generation unit. The test specification generation unit generates a test specification for the test target screen program from the screen definition information. The test support apparatus can further include a test report generation unit. The test report generation unit generates a test report using a test specification generated by the test specification generation unit and a test execution result of the test target screen program obtained from the test execution unit.

With the above mentioned configuration, the test support class can include the functions of supporting input of input test data, recording a test result when the test is manually or automatically conducted, visually displaying a test execution portion on the screen, and manually or automatically conducting a test using new input test data or the input data for the previous test execution result. At this time, it includes the function of displaying a warning when the execution result of the test conducted using the input data for the previous test execution result is different from the previous test execution result. Furthermore, the test support class can also include the function of supporting the measurement of the performance of the test target screen program.

According to another aspect of the present invention, a method for supporting a test of a screen program performed using a graphic user interface comprises obtaining screen definition information, generating a test support class which is a subclass (a child class) inheriting a class of a test target screen program according to the screen definition information, and is a class for testing a screen program, and conducting a rest of the test target screen program using the generated test support class.

Furthermore, according to a further aspect of the present invention, a storage medium used in a computer for supporting a test of a screen program performed using a graphic user interface stores a program used to direct a computer to perform the steps of receiving screen definition information about a test target screen program, and generating a test support class which is a subclass of a class of a test target screen program in relation to inheritance of object-oriented programming for testing the screen program.

Furthermore, a storage medium used in a computer for conducting a test of a screen program performed using a graphic user interface can store a program used to direct the computer to perform the steps of receiving new input test data or input data for the previous test execution result, and conducting a test of the test target screen program using a test support class which is a subclass of the class of the test target screen program in relation to inheritance of object-oriented programming for testing the screen program using the received input data.

As described above, according to the present invention, a test support class which is a subclass inheriting the class of a test target screen program, and a class for testing a screen program is generated, and a test is conducted on a test target screen program using the generated test support class.

### BRIEF DESCRIPTION OF THE DRAWINGS

The features and advantages of the present invention will be more clearly appreciated from the following description taken in conjunction with the accompanying drawings in which like elements are denoted by like reference numerals and in which:

FIG. 1 is a block diagram of the configuration showing the principle of the present invention;

FIG. 2 shows the correspondence between a test target screen program and a test support class according to the present invention;

FIG. 3 shows a test support function added to a screen program;

FIG. 4 shows the concept of generating a test specification;

FIG. 5 shows the concept of generating a test support class;

FIG. 6 shows the concept of generating a test report;

FIG. 7 shows the entire operation of the test support apparatus according to the present invention;

FIG. 8 shows the method of realizing the test support function according to the present invention;

FIG. 9 shows a practical example of generating a test specification according to the screen definition information;

FIG. 10 shows a practical example of setting test data in item unit;

FIG. 11 shows a practical example of setting test data in screen unit;

FIG. 12 shows a practical example of automatic test execution;

FIG. 13 shows a practical example of visual representation of a passage process;

FIG. 14 shows an example of an operation of the performance measurement support device;

FIG. 15 shows an example of an operation of the test report generation device;

FIG. 16 shows the general explanation of an example of an operation of the test support apparatus;

FIG. 17 shows an example of a conventional method for realizing a test support function;

FIG. 18 shows the method for realizing a test support function according to the present invention corresponding to the method shown in FIG. 17;

FIG. 19 is a flowchart of the process of the test specification generation device;

FIG. 20 is a flowchart of the process of the test support class generation device;

FIG. 21 shows an example of an operation of the test data input device;

FIG. 22 is a flowchart of the process of the test data input device;

FIG. 23 shows an example of an operation of the test data setting device;

FIG. 24 is a flowchart of the process of the test data setting device;

FIG. 25 shows an example of an operation of the automatic test execution device;

FIG. 26 is a flowchart of the process of the automatic test execution device;

FIG. 27 shows an example of an operation of the visual representation device of a passage process;

FIG. 28 is a flowchart of the process of the visual representation device of a passage process;

FIG. 29 shows an operation of the performance measurement support device;

FIG. 30 is a flowchart of the process of the performance measurement support device;

FIG. 31 shows an example of an operation of the performance measurement support device when a monitor item is changed;

FIG. 32 is a flowchart of the process of the test report generation device;

FIG. 33 shows test support by the test support B class in a test environment;

FIG. 34 shows an employee registration screen in the actual program execution environment; and

FIG. 35 shows the process of loading a program on a computer for realizing the embodiments according to the present invention.

### DETAILED DESCRIPTION OF THE PREFERRED EMBODIMENTS

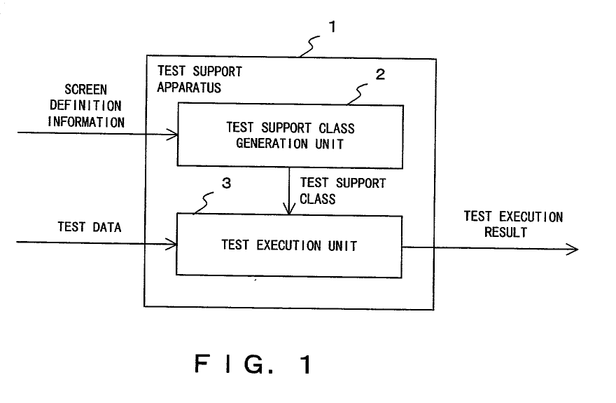

FIG. 1 is a block diagram of the configuration showing the principle of the present invention. FIG. 1 is a block diagram of the configuration showing the principle of the test support apparatus of a GUI system program for supporting a test of a screen program performed using a graphic user interface (GUI).

In FIG. 1, a test support apparatus 1 comprises a test support class generation unit 2 and a test execution unit 3. The test support class generation unit 2 (test support class generation device) receives the screen definition information about a test target screen program as an input, and generates a test support class which is a subclass (child class) in relation to inheritance of object-oriented programming for the class (a super-class, or a parent class) of the test target screen program, and a class for testing a screen program.

The test execution unit 3 conducts a test of the test target screen program using the test support class generated by the test support class generation unit 2.

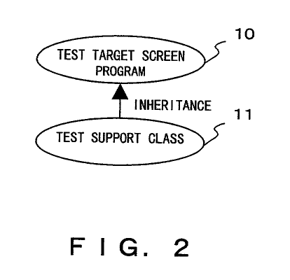

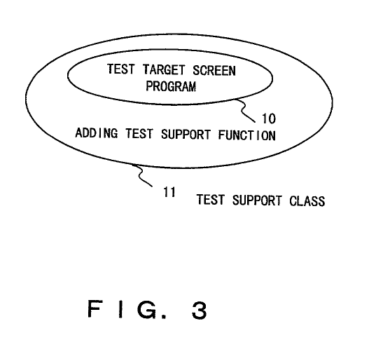

The basic concept of the present invention is described below by referring to FIGS. 2 through 6. FIGS. 2 and 3 show how to use a test support class based on the concept of inheritance in object-oriented programming to conduct a test of a screen program performed using a graphic user interface (GUI).

As shown in FIG. 2, according to the present invention, the conventional general-purpose support tools are not used, or no test drivers are generated to support a test executing operation, but a test is conducted on a test target screen program 10 by using a test support class 11 related to the test target screen program 10 in relation to inheritance in object-oriented programming.

FIG. 3 shows the configuration of a test support class by the extension of a screen program. By extending the test target screen program 10 and adding a test support function, the test support class 11 can be configured.

According to an embodiment of the present invention, a test specification is generated, a test is conducted using the above mentioned test support class, and a test report about the test result is generated.

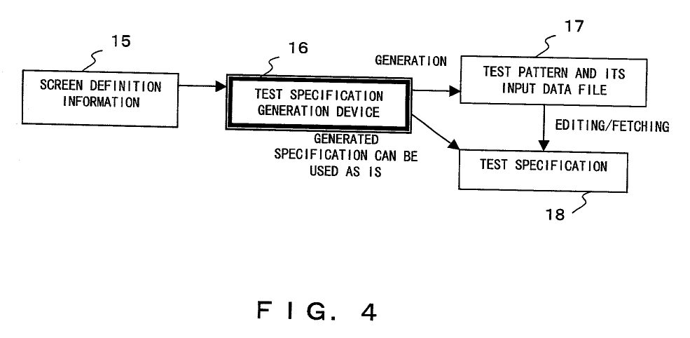

FIG. 4 shows how to generate a test specification. In FIG. 4, a test pattern and an input data file 17 are generated by a test specification generation device 16 from screen definition information 15, the input data file is edited/fetched, and a test specifications 18 are generated. As the test specifications 18, the output of the test specification generation device 16 can be used as is.

A test pattern can be a pattern from which a normal result is expected, a test pattern from which an abnormal result, that is, an error, etc. is detected, etc. Although the test specifications 18 can be generated in an Excel format (The Excel format is a format used in a calculation software of Microsoft Corporation), etc., the format has to be converted into a file in a CSV format as a file containing data items delimited from each other by a comma such that a computer for conducting a test can read the data.

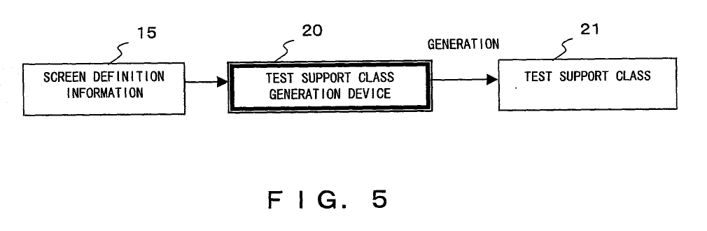

FIG. 5 shows the concept of generating a test support class. A test support class, that is, a screen program to which a test support function has been added as described by referring to FIG. 3 is generated based on the definition of the screen program. That is, a test support class 21 is generated from the screen definition information 15 by a test support class generation device 20. The class name (of a parent) of the test target screen program 10 to be tested is described in the screen definition information 15, and the test support class 21 is generated as a child class by inheriting the class.

When a test is conducted, the test target screen program 10 to be tested is activated by the execution of the generated test support class 21, and a screen with the test support function is displayed. The following six functions are added as the test support functions to the screen program.

The first function is an input support function of a test pattern and input test data. Using the function, a test specification or a generated input data file is read, a list of input data is displayed corresponding to the entry on the screen, and a test operator is supported to select and input any of the input data.

The second function is a record function for an execution result. The execution date and time of a test, a test case number, input data, an execution result, etc. can be recorded in a file by this function.

The third function is a function of automatically conducting a test. Using an input data file based on a test specification or the input data for the execution result of the previous test, the input data is sequentially and automatically input to the screen program to be tested, and the execution result can be recorded.

The fourth function is a comparison function of comparing a test result with the result of the previous test when the test is conducted again. If different results are obtained between the current and the previous test results when a test is automatically or manually conducted using the input data for the execution of the previous test using the automatic execution function as the above mentioned third function, then a warning is displayed for the test operator.

The fifth function is a function of visually representing a passage portion in a program process when a test is conducted. Using this function, a test operator can be notified whether or not a normal process has been performed by displaying a control (parts on the screen) color corresponding to a passage portion in the program process on the screen in different colors, for example, blue and yellow, between a normal process and an abnormal process.

The sixth function is a performance measurement support function used when a program is executed. For example, when a screen activating time, a response time when a button is pressed on the screen, etc. are measured, the results can be displayed and recorded. To measure the time from the activation of a program to the display of the screen, the time from pressing a button to the completion of a corresponding process, etc., the time measurement starting/ending process in consideration of the starting/ending time of the process is added and the performance of the program is measured, and the measurement result can be displayed on the screen and stored in a file.

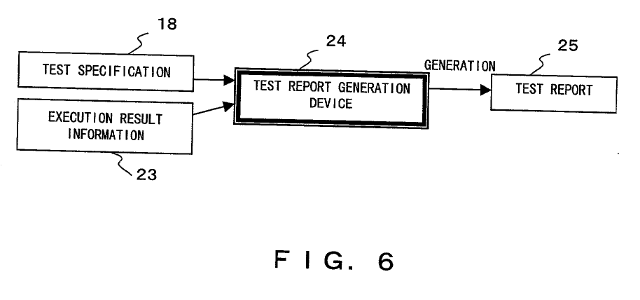

When a test is completed, a test report is generated. As shown in FIG. 6, a test report generation device 24 generates a test report 25 using the test specifications 18 and execution result information 23.

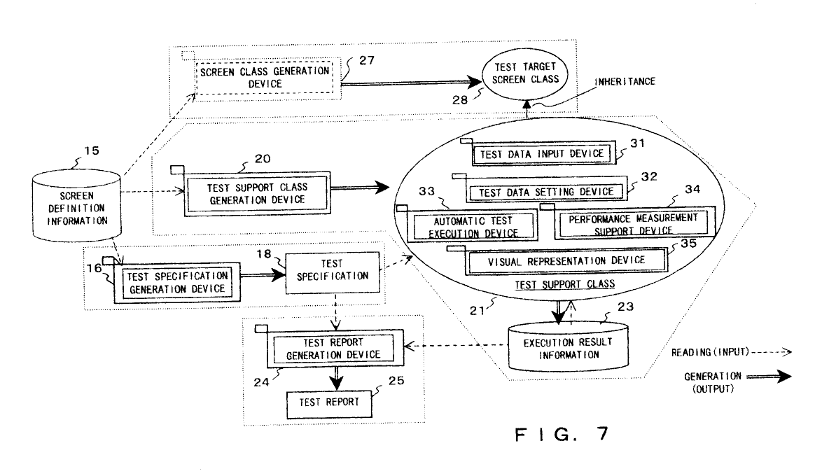

FIG. 7 shows the entire configuration of the test support apparatus. FIG. 7 basically shows the summary of the contents of FIGS. 4 through 6. Additionally, the configuration includes a screen class generation device 27 for generating a test target screen class 28 corresponding to the test target screen program from the screen definition information 15. Since the generation of the test target screen class 28 from the screen definition information 15 is not associated directly with the present invention, the explanation is omitted here.

In FIG. 7, the test support class 21 comprises five devices corresponding to the above mentioned six functions, that is, a test data input device 31, a test data setting device 32, a automatic test execution device 33, a performance measurement support device 34, and a visual representation device 35 for a passage process. The operations of these devices are described later.

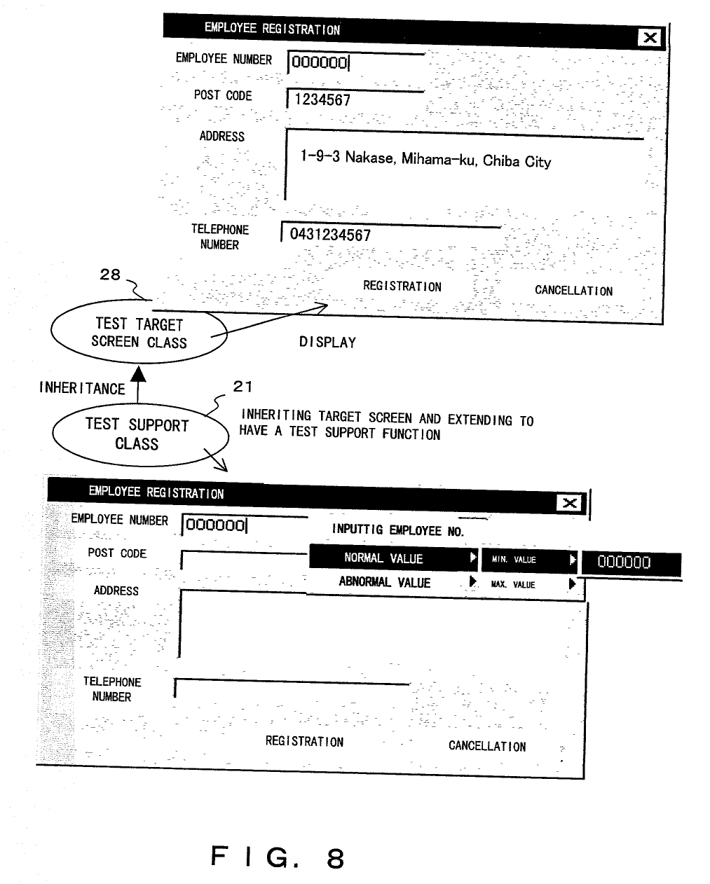

FIG. 8 shows the method for realizing a test support function based on inheritance in object-oriented programming. In FIG. 8, the test target screen class 28 is a class of a screen program to be tested by a test operator, and is stored in a file different from the file storing the test support class 21. Therefore, after completing the test, the test support function of the test support class 21 is separated, and only the test target screen class 28 can be executed to perform the actual screen program.

The test support class 21 (subclass) relates to the test target screen class 28 (super-class) in inheritance, inherits a test target screen, and is extended to a class provided with a test support function. The actual test target screen program is tested using the test support class 21 which inherits the test target screen class 28. The test target screen class 28 seems to have been extended to the test operator. The test support class 21 has the functions such as the above mentioned input support function, automatic test execution function, performance measurement support function, execution result record function, etc. as test support functions in addition to the function of the test target screen class 28.

Apparently, the test operator seems to conduct a test of the test support class 21. However, since a process performed by pressing a button is realized by invoking the process of the test target screen class 28, the test operator actually conducts a test of the test target screen class 28. Thus, a test of a test target screen program 28 can be conducted by inheriting the test target screen class 28 without amending the test target screen class 28 itself. In the conventional technology, it is necessary to amend a test target screen program source itself when a test is conducted. However, according to the present invention, it is not necessary to amend the test target screen class 28, and there arises no problem with the execution of a test although the control (parts) on the screen is changed. In the conventional technology, a test target screen class and a test support class are provided, but they are quite different from each other, and only the test support class knows the test target screen class.

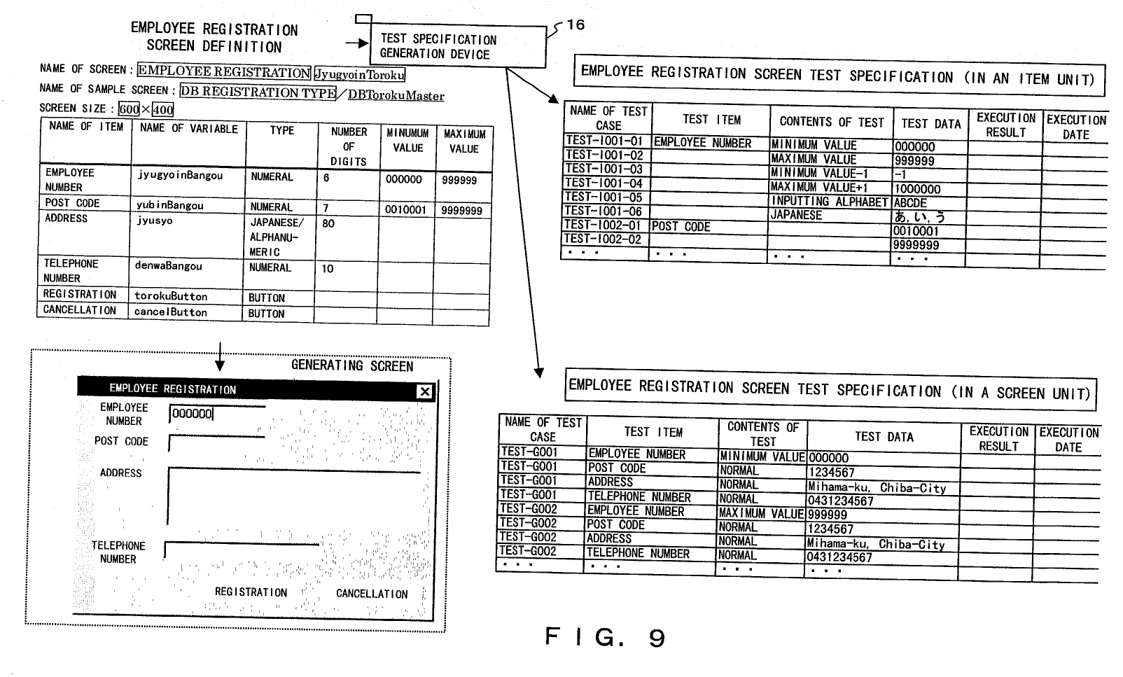

The operations of the test support apparatus according to the present invention are described below by referring to FIGS. 9 through 15 using a practical example of screen definition information.

FIG. 9 shows how to generate a test specification according to the screen definition information. Actually, the generation of a specification for a test of an employee registration screen is described below. In FIG. 9, the employee registration screen definition on the upper left defines the variable names and the types of six items from the employee number to the cancellation. The number of digits is defined for the four items from the employee number to the telephone number. The range, that is, the maximum value and the minimum value, is defined for the employee number and the post code. From the employee registration screen definition, the employee registration screen on the lower left is generated. The detailed explanation is omitted as described above. The test specification generation device 16 generates an employee registration screen test specification.

As a test specification, a specification in an item unit and a specification in a screen unit are generated. The specification in an item unit normally comprises a plurality of test cases for one item of the employee registration screen definition. For example, a test case for the employee number item comprises six test cases from TEST-I001-01 to TEST-I001-06. For example, the first test case tests the minimum value. The test data indicates 000000 which is a normal registering employee number. Therefore, the employee registration using the data is to be correctly performed. In addition to such a normal test specification, for example, the test data ‘−1’ corresponding to the third test case refers to an abnormal test specification. Using such data, no employee registration can be correctly performed.

The test specification in a screen unit refers to test data in a single screen unit by setting four items to be registered, that is, from the employee number to the telephone number, as a set. For example, the test source of TEST-G001 comprises the data of the first four digits in the test specification. When there are items omitted in the employee registration screen definition, a test specification is generated at, for example, an instruction of a user.

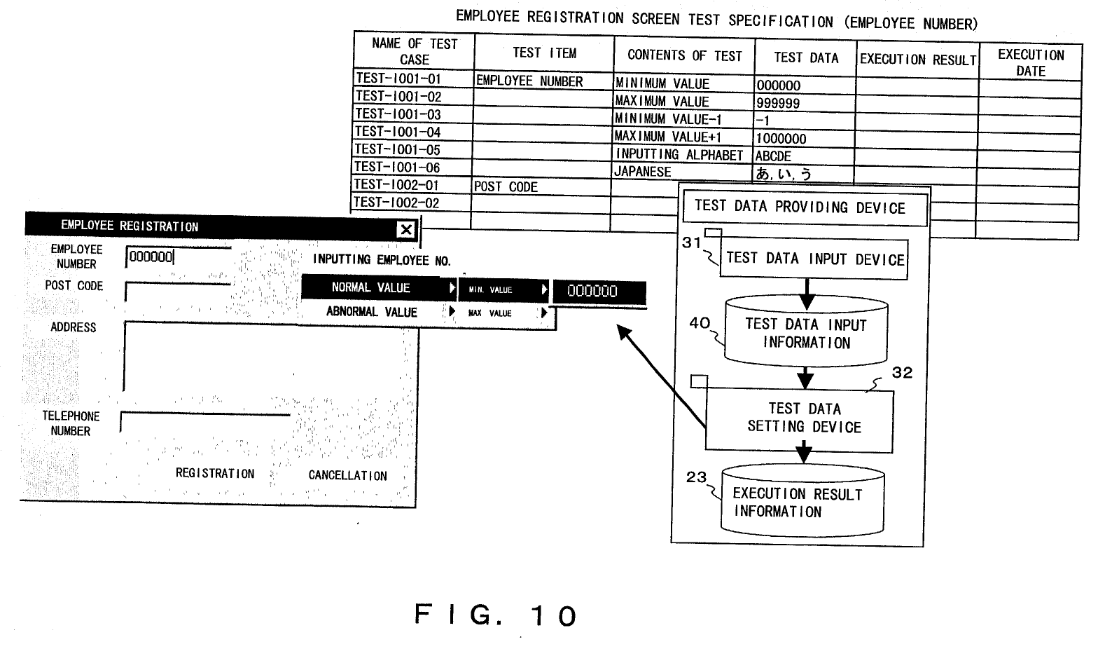

FIG. 10 shows the operations of a test data providing device for embedding test data in a field of the employee registration screen. The test data providing device is basically comprises the test data input device 31 and the test data setting device 32. The test data input device 31 reads a test specification, and generates test data input information 40 in the format readable by the test data setting device 32. The test data setting device 32 reads the test data input information 40, displays a pop-up menu on the screen according to the input information, and embeds a value selected by the test operator in an input field on the screen.

In FIG. 10, ‘000000’ corresponding to the employee number is selected as the first test data, and embedded in the input field of the employee number on the screen. As described above, the employee number can be input only by numerals as an acceptable value, and the valid value can be 000000 through 999999. The characters other than numerals, for example, any alphabets or Japanese characters are rejected as abnormal values. A normal value is correctly embedded in an input field, and that the correct data has been embedded, that is, test data has been set, is recorded in the execution result information 23 for storing test data, test results, etc. A test operator can input test data only by operating a mouse, thereby reducing the number of steps of a testing process. The set test data can be sequentially reduced to immediately confirm the test data not set yet.

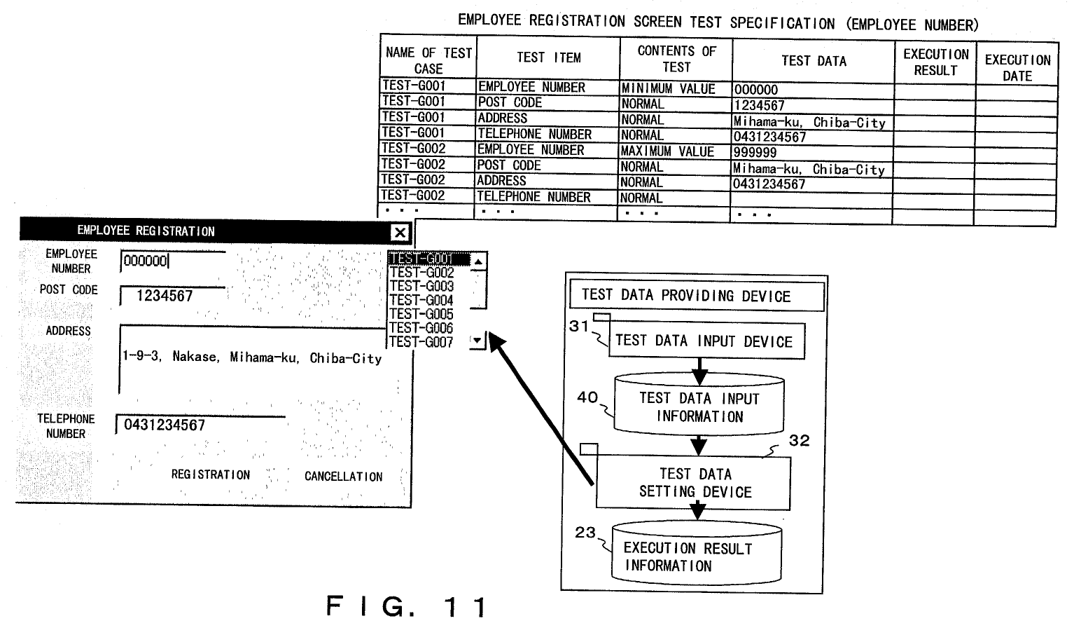

FIG. 11 shows the operation of setting test data in a screen unit by the test data providing device. In the test data setting operation in a screen unit, a plurality of names of test cases each comprising a plurality of test items are displays on a pop-up menu. In this example, each input field is correctly embedded with four pieces of data corresponding to the test case of TEST-G001, that is, from the employee number to the telephone number. In setting test data in a screen unit, the data for the set test case can be sequentially reduced, thereby immediately confirming the test case which has not been set yet.

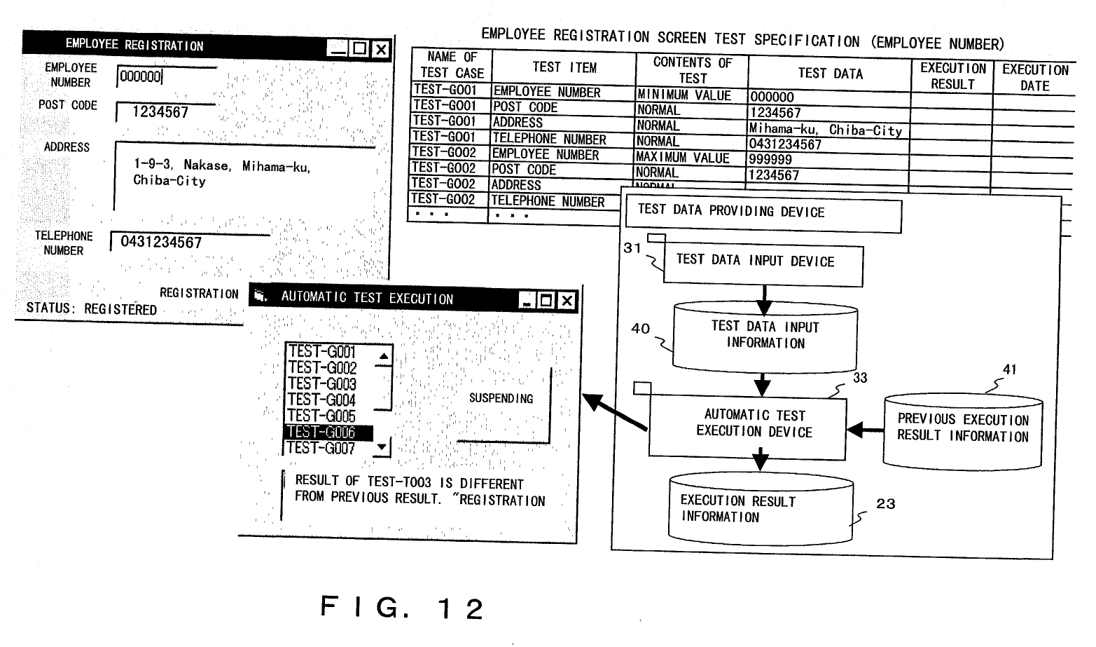

FIG. 12 shows an automatic test executing operation. A test is automatically conducted by the test data input device 31 and the automatic test execution device 33 basically. The input data based on a test specification is converted by the test data input device 31 as described above into the format of the test data input information 40, and is provided for the automatic test execution device 33. Previous execution result information 41 stores execution results obtained in the previous processes, and stores both input data and execution results.

FIG. 12 shows the employee registration as the content of an automatic test, and the screen indicates that an employee has been correctly registered using the test data of the test case TEST-G001. That is, a value is automatically set in an input field for each test case, and a button is automatically pressed. The execution result is stored as the execution result information 23. These operations are sequentially performed for each test case until a suspending button is pressed as described later.

Also when a test specification is prepared in an item unit, a test can be automatically conducted. When the previous execution result information 41 is used, a warning is issued if the current execution result is different from the previous execution result. In this example, the result of the TEST-G003 is different.

Thus, when a registration button on the employee registration screen is pressed, the input employee number, post code, telephone number, etc. are checked, and an error message is displayed if, for example, the employee number is not in the range from the minimum value to the maximum value. If the input data is a normal value, the registering process on the server side connected to the personal computer displaying, for example, an employee registration screen is invoked, and the database not shown in the attached drawings is registered.

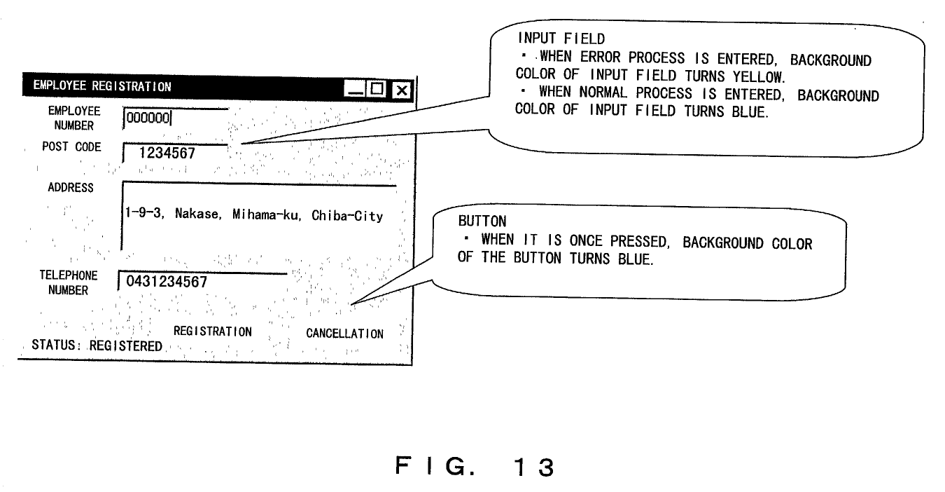

FIG. 13 shows an example of an operation of visually representing a passage process of a program. For example, to avoid the omission of a test, a test support logic function of visually indicating a rest result is embedded in each control (parts) on the screen. For example, by using different colors for the background of the control between a normal case and an abnormal case, the visual representation of a passage process result of a program can be realized.

In each input field, the background color turns yellow when an error process is entered, and blue when a normal process is entered, thereby visually representing whether or not the process has been normally performed. As for a button, when it is once pressed, the background color of the button turns blue to represent that it has been pressed.

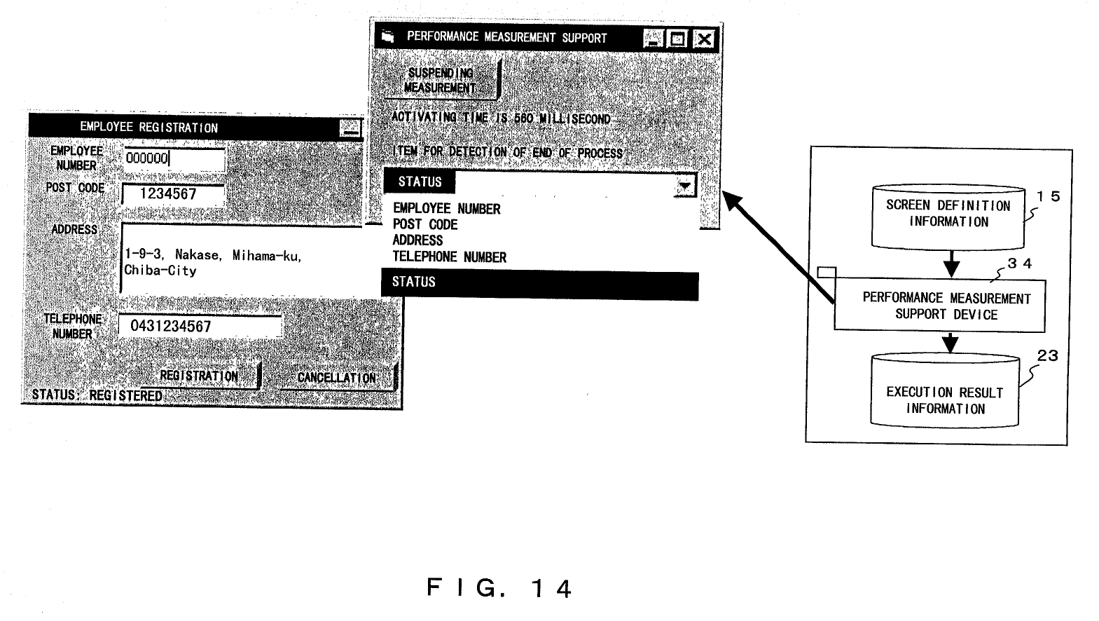

FIG. 14 shows an example of an operation of the performance measurement support function. The performance measurement support device 34 measures various performance according to the screen definition information 15 when a test is conducted, and the result is stored in the execution result information 23.

The performance measurement support device 34 measures, for example, the time required to display the screen as an activating time when the test target screen is activated, and displays the result. In this example, the time required to display the employee registration screen is 560 millisecond.

The performance measurement support device 34 measures the time required to complete a corresponding process by a button pressed on the test target screen. The completion of the process is detected by a change of a character string of a specified item, or the invocation of a measurement completing method. The elapsed time is displayed and the time data is stored in the execution result information 23.

The performance measurement support device 34 obtains a list of items of, for example, the employee registration screen definition from the screen definition information 15, stores the termination of the process when a button is pressed as a probable item to be detected, and has the test operator specify it as a measurement item. For example, when registration is completed with a registration button pressed, the field changes from blank to ‘registered’, and the performance measurement support device 34 detects the change of the character string, and detects that the process having being performed when the registration button is pressed has been completed. The measurement of a time required to complete the process can also be performed by invoking the above mentioned measurement completing method.

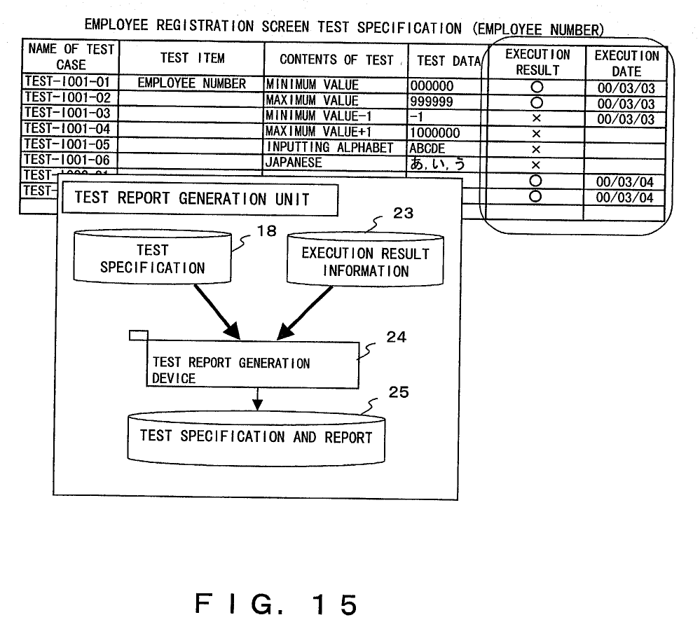

FIG. 15 shows an example of an operation of the test report generation device. The test report generation device 24 matches the execution result information 23 obtained by conducting a test with the test specifications 18 as described above, and enters the execution result and the execution date not entered yet in the test specifications 18, thereby generating the test report 25.

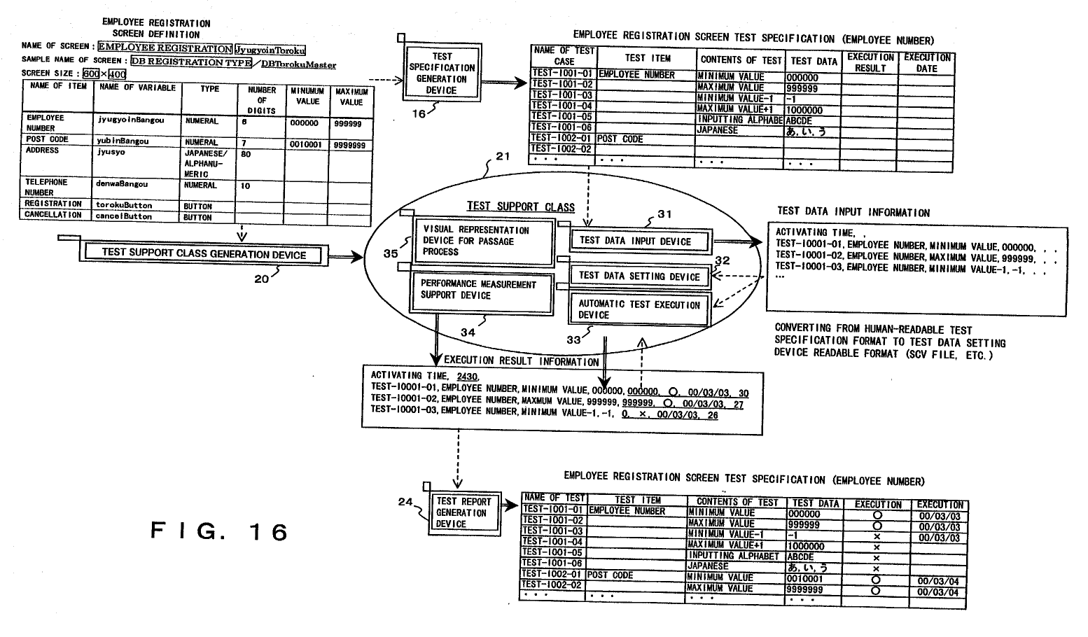

FIG. 16 shows an example of the entire operation of the test support apparatus. In FIG. 16, corresponding to the test data input information, the execution result information such as a test execution result, an execution date and time, etc. and the performance measurement information such as an activating time, a response time, etc. are stored. The first line of the execution result information shows the activating time in millisecond unit, and the second and subsequent lines show the value displayed as a result of inputting test data in addition to the test data input information, the determination result represented by o or x indicating whether the execution result is normal or erroneous, the execution date and time, and the response time (millisecond) from the input of data to the display of a result with underlines.

For example, the fourth line (a result of the test case of TEST-I0001-03) of the execution result information indicates that the contents of the test is ‘minimum value of −1’, the result is obtained from the test data of ‘−1’, and the first ‘0’ of the underline portion indicates that the input data is not normal.

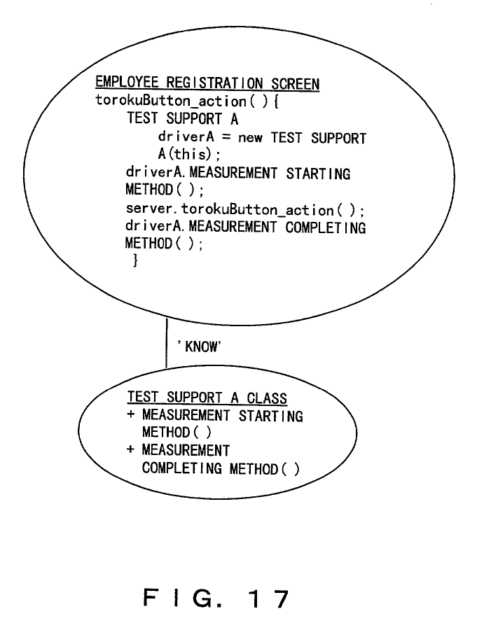

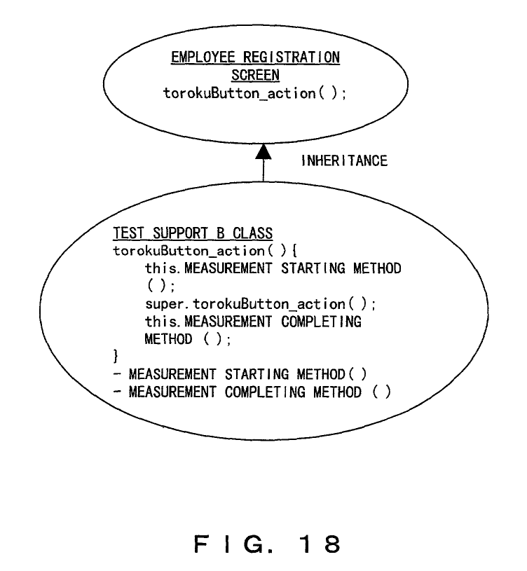

Described below further in detail are the method for realizing the test support function according to the present invention, the flowchart of the process of the test support apparatus, etc. FIGS. 17 and 18 show the conventional system and the present invention used to realize a test support function. In this example, the above mentioned employee registration screen is defined as a test target screen, and the time from when the registration button is pressed until the registration is completed is measured as a process of adding a performance measurement function.

FIG. 17 shows the method for realizing a conventional system, and a program is added such that the measurement starting method and the measurement completing method are invoked during the process of pressing a registration button in the employee registration screen class. The difference from the source program of the employee registration screen class shown in FIG. 18 is clear.

In FIG. 17, it is necessary to amend the employee registration screen class, the test support A class is different from the employee registration screen class, the screen is displayed separately, and there is only the relationship between the test support A class and the employee registration screen class that they simply know each other. The measurement starting method is, for example, a method for activating a stopwatch, and the measurement completing method is a method for stopping a stopwatch.

In the system according to the present invention shown in FIG. 18, it is not necessary to amend the employee registration screen class, but a source program for performing a process when a registration button is pressed is generated in a test support B class, a test is conducted on the employee registration screen class only by performing the test support B class, and the screen is displayed also by the test support B class.

In the test support B class, measurement starting and completing methods are embedded before invoking the process method when a button is pressed, that is, torokuButton-action( ) at a super-class.

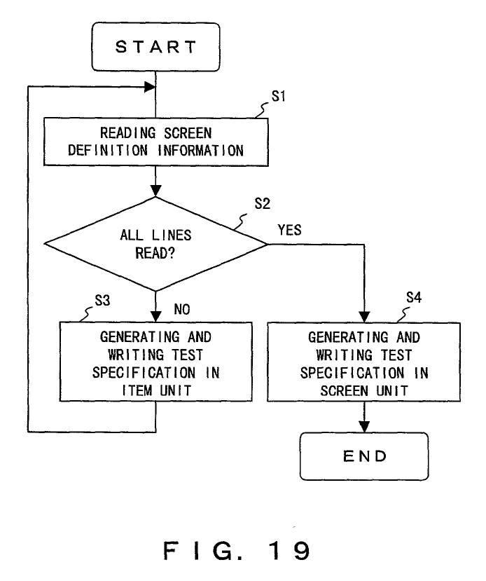

FIG. 19 is a flowchart of the process of the test specification generation device. In FIG. 19, when the process starts, the screen definition information is first read in step S1, and it is determined in step S2 whether or not all lines have been read. If they have not been read yet, a test specification is generated in an item unit in step S3 and it is written to the specifications, and the processes in and after step S1 are repeated. If it is determined in step S2 that all lines have been read a test specification is generated in a screen unit in step S4, and it is written to the test specifications, thereby terminating the process.

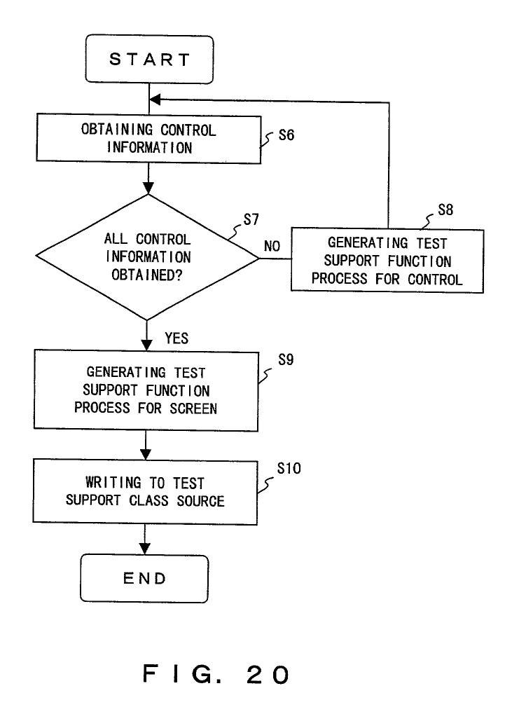

FIG. 20 is a flowchart of the process of the test support class generation device. In FIG. 20, when the process starts, the control information, that is, the information about the parts on the screen, etc. is first obtained in step S6, it is determined in step S7 whether or not all control information bas been obtained. If it has not been obtained yet, a test support process function for the control, for example, the process of the time measurement function up to the end of the registration process performed when a registration button is pressed, etc., is generated in step S8, and the processes in and after step S6 are repeated.

If it is determined in step S7 that all control information has been obtained, the test support process function for the screen is generated in step S9, and the test support process function generated in the test support class source in step S10 is written, thereby terminating the process. In step S9, a test data input device, a test data setting device, a automatic test execution device, a performance measurement support device, etc. are generated as test support process functions, and provided in the test support class.

A test support class is basically generated from the screen definition information, that is, the screen definition information of the test target screen class as described above. That is, the information about the maximum value, the minimum value, etc. of an attribute of an item corresponding to the control, etc. on the screen is obtained from the screen definition information, thereby generating a test support class.

On the other hand, as described by referring to FIG. 7, it is also possible to generate a test support class from the test target screen class 28 generated by the screen class generation device 27. That is, for the control, etc. on the screen, necessary information is obtained from the test target screen class 28, and the information about the attribute information about each item, that is, the maximum value, the minimum value, etc. is specified, for example, by a user, thereby generating a test support class.

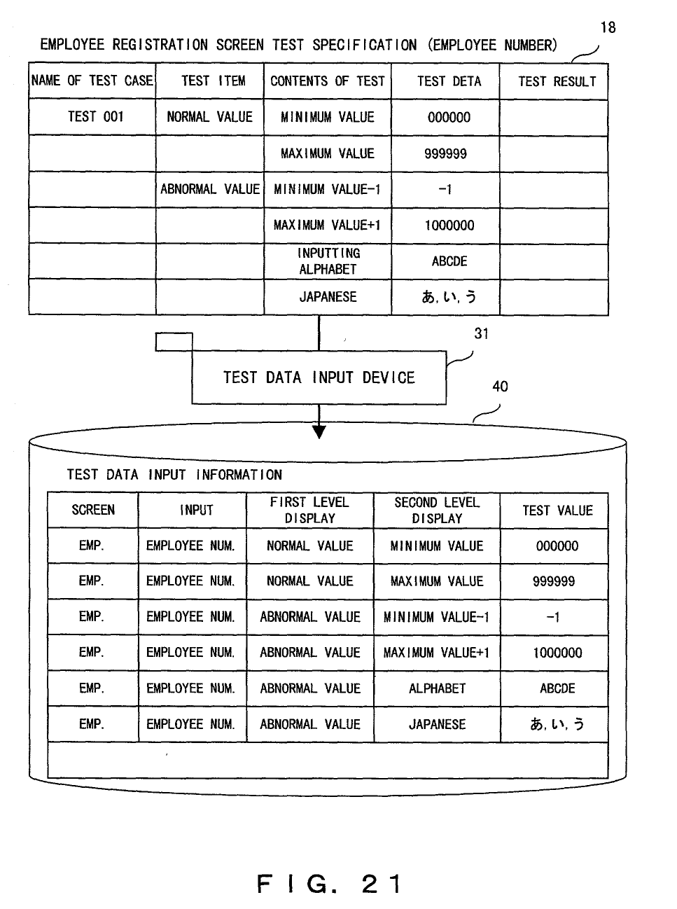

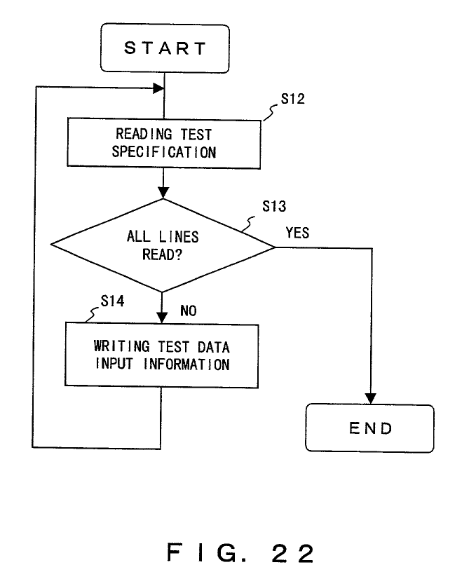

FIG. 21 shows an example of the operation of the test data input device. FIG. 22 is a flowchart of the process. In FIG. 21, the test data input device 31 reads, for example, the employee registration screen test specifications (employee number) 18, converts the specification data, for example, in the Excel format into the test data input information 40 readable by the automatic test execution device, and outputs the information.

The test data input information 40 comprises five items, that is, a screen name, an input field, a first level display data, a second level display data, and a test value. The first level display data corresponds to the test item of the test specifications, and the second lavel display data corresponds to the contents of the test.

When the process starts according to the flowchart of the process of the test data input device shown in FIG. 22, the test specifications are first read in step S12, and it is determined in step S13 whether or not all lines have been read. If they have not been read yet, the data is converted into the test data input information and then written, the processes in and after step S12 are repeated, and the process terminates at the time when it is determined that all lines have been read in step S13.

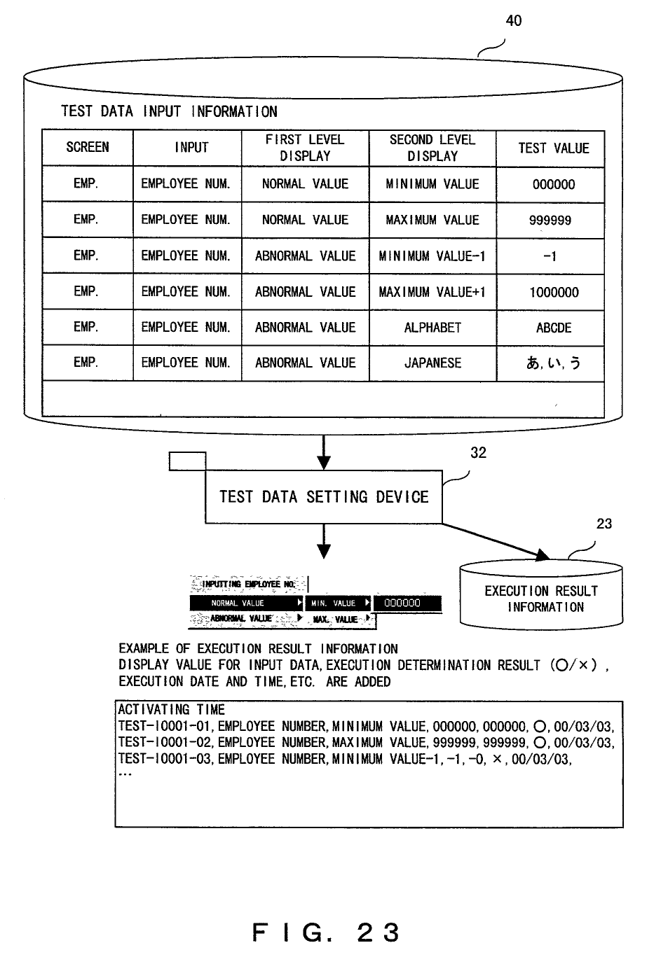

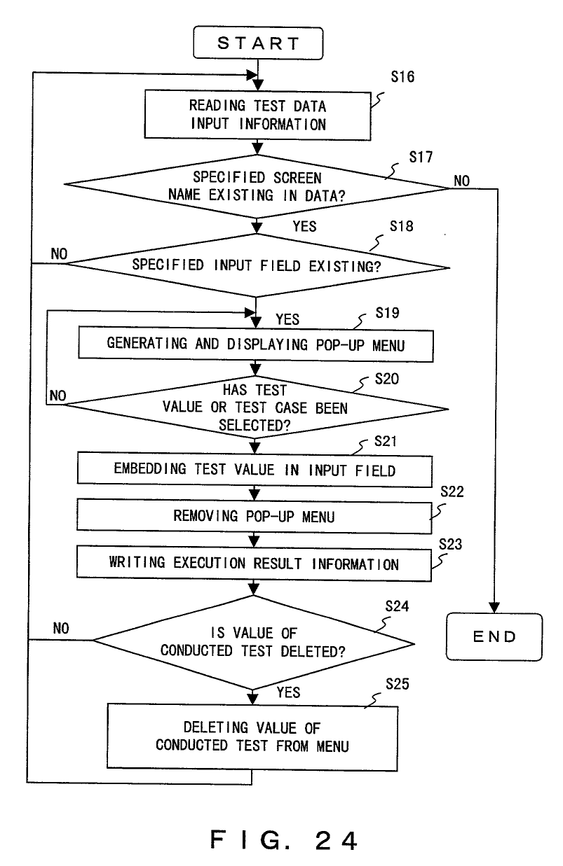

FIG. 23 shows an example of an operation of the test data setting device. FIG. 24 shows a flowchart of the process. In FIG. 23, the test data setting device 32 displays a pop-up menu on the screen according to the test data input information 40, embeds a test value selected by the test operator in the input field, and outputs the execution result information 23 about whether or not data has been correctly set, etc. As the execution result information 23, the execution result other than the activating time in the execution result information described above by referring to FIG. 16 is output.

When the process starts according to the flowchart of the process of the test data setting device shown in FIG. 24, the test data input information is read in step S16, and it is determined in step S17 whether or not, for example, the name of the screen specified by the test operator exists in the data. If it exists, it is determined in step S18 whether of not there is the specified input field. If it does not exist, then the processes in and after step S16 are repeated.

When the specified input field exists in step S18, a pop-up menu is generated and displayed on the screen in step S19, and it is determined in step S20 whether or not the test operator has selected a test value or a test case. If any of them has not been specified, then the processes in and after step S19 are repeated.

If it is determined that a test value or a test case has been selected, the test value is embedded in the input field in step S21, the pop-up menu is removed from the screen in step S22, the execution result information describing the test value as having been correctly set is written in step S23, it is determined in step S24 whether or not the value of the conducted test is to be deleted. If it is not to be deleted, the processes in and after step S16 are repeated.

When the value of the conducted test is to be deleted in step S24, the value of the conducted test is removed from the data to be displayed in the pop-up menu in step S25, and the processes in and after step S16 are repeated. Thus, by deleting the value of the conducted test, the value of a test or a test case which has not been performed can be immediately checked as described above.

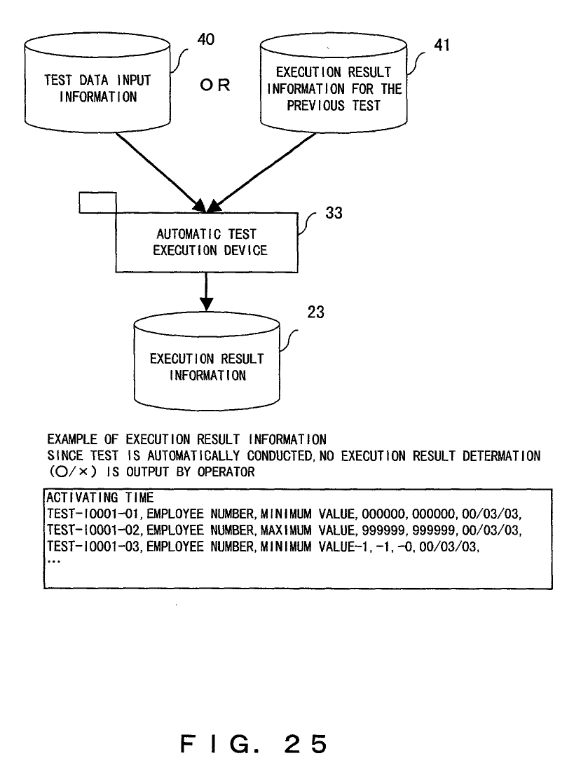

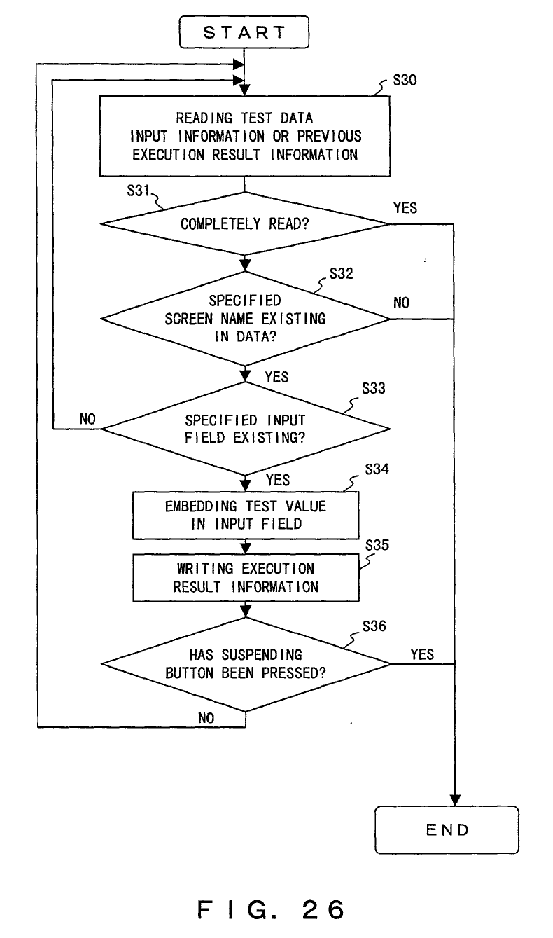

FIG. 25 shows an example of an operation of the automatic test execution device. FIG. 26 is a flowchart of the process of the device. As described by referring to FIG. 12, the automatic test execution device 33 automatically conducts a test according to the test data input information 40 or the previous execution result information 41, and outputs the result as the execution result information 23. The execution result information shown in FIG. 25 is different from the execution result information shown in FIG. 16 in that it does not contain the measurement result of the activating time, and that o or x indicating to the test operator for automatic execution of a test as to whether or not the execution result is normal is not displayed.

When the process starts as shown in FIG. 26, the test data input information or the previous execution result information is first read in step S30, and it is determined in step S31 whether or not the information has completely read. If it has been completely read, the process immediately terminates. If not, it is determined in step S32 whether or not the name of the screen specified by the operator exists in the data. If it does not exist, the process immediately terminates.

If the specified name of the screen exists, it is determined whether or not the input field specified in step S33 exists. If not, the processes from step S30 are repeated. If the input field exists, then the test value is embedded in the input field in step S34, the execution result information, for example, the information as to whether or not the test value has been correctly embedded is written, and it is determined in step S36 whether or not a suspending button has been pressed. If it has not been pressed, then the processes in and after step S30 are repeated. According to the present embodiment, it is determined that a test is automatically conducted until the suspending button is pressed, and the process terminates when it is determined in step S36 that the suspending button has been pressed.

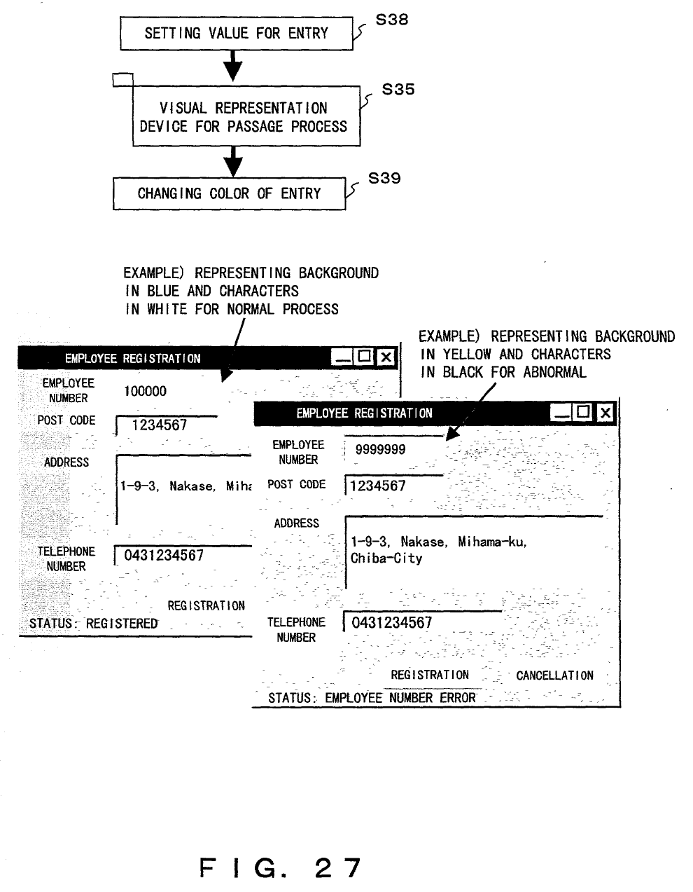

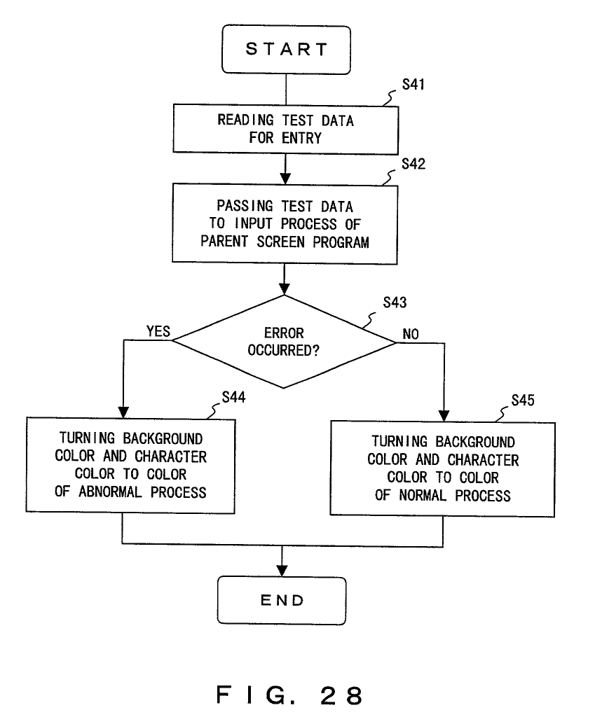

FIG. 27 shows an example of an operation of the visual representation device for a passage process. FIG. 28 is a flowchart of the process of the device. In FIG. 27, for example, when a value is set for an entry by the test operator, the visual representation device 35 for a passage process indicates in step S39 to the test operator whether or not the color of the entry has been changed, that is, a normal input data has been set, by changing the background color of the input field. In the example shown in FIG. 27, the background color is blue and the characters are white when normal data is input while the background color is yellow and the characters are black when abnormal data is input.

When the process starts according to the flowchart shown in FIG. 28, the test data for an entry is first read in step S41, and passed to the input process of the parent screen program, that is, the test target screen program which is the parent (super-class) of the test support class relating to inheritance of object-oriented programming in step S42, it is determined in step S43 whether or not an error, that is, abnormal input data has been detected. When an error occurs, the background color and the color of the characters of the input field are changed into those indicating an abnormal process in step S44, thereby terminating the process. If no errors occur, the process terminates after each of the background color and the character color has indicated the color of the normal process in step S45, thereby terminating the process.

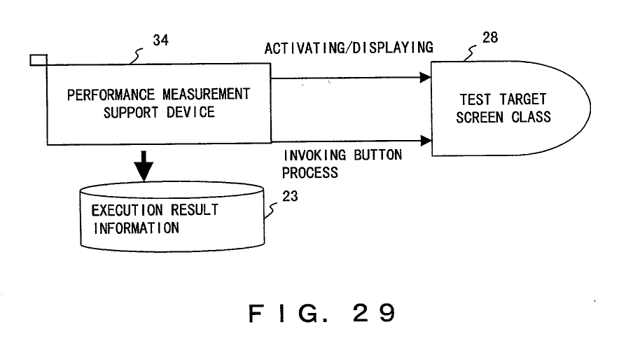

FIG. 29 shows an operation of the performance measurement support device. 30 is a flowchart of the process. In FIG. 29, the performance measurement support device 34 measures the time required from, for example, the activation of the test target screen class 28 to the display of the screen, outputs the result as the execution result information 23. Furthermore, the performance measurement support device 34 invokes the process corresponding to a button for the test target screen class 28 when, for example, the registration button is pressed for the employee registration, and outputs the elapsed time as the execution result information 23 when the process corresponding to the pressed button is completed.

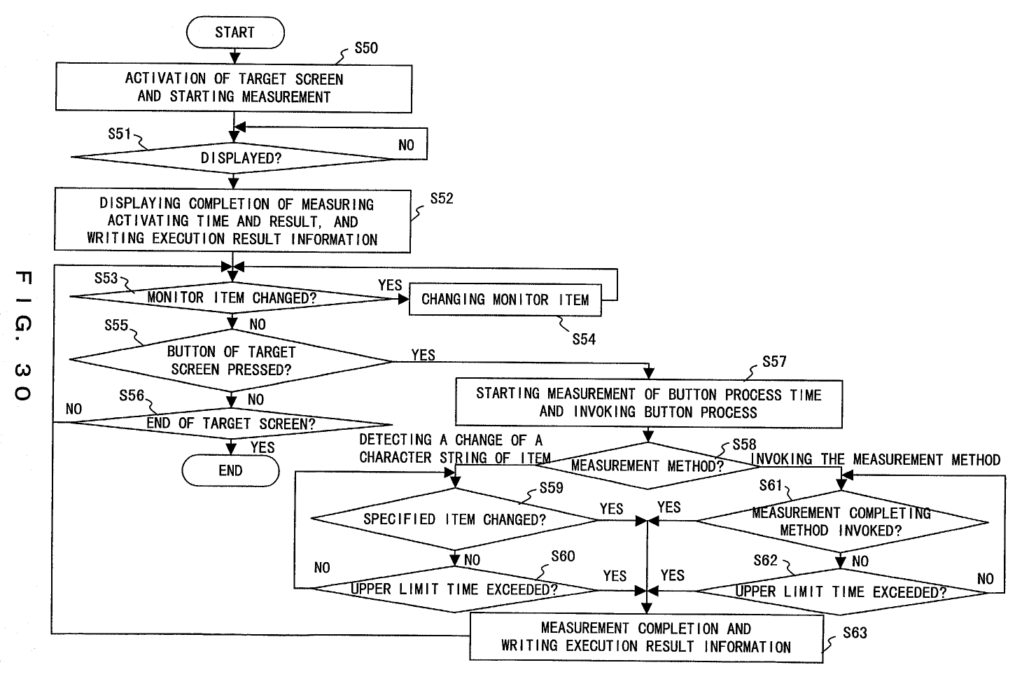

When the process starts according to the flowchart shown in FIG. 30, the test target screen class is activated and the measurement of the time required to display the screen is started in step S50. In step S51, it is determined whether or not the screen has been displayed. If it has not been displayed yet, the determination continues. When it is determined that the screen has been displayed, then the completion of the measurement of the activation time and the result are displayed in step S52, and the execution result information is written.

Then, in step S53, it is determined whether or not a monitor item has been changed. If it has been changed, then the processes in and after step S53 are repeated after the monitor item has been changed in step S54. If it has not been changed, then it is determined in step S55 whether or not a button on the target screen, for example, the registration button, has been pressed. If it has not been pressed, then it is determined in step S56 whether or not the target screen has been completed. If it has not been completed, then the processes in and after step S53 are repeated. If it has been completed, then the process terminates.

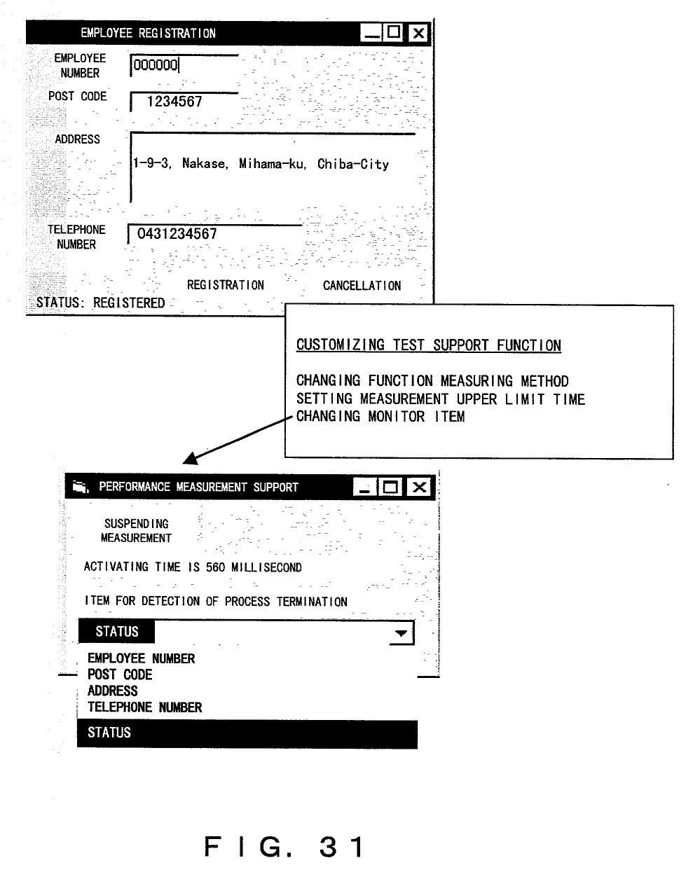

The change of the above mentioned monitor item is described below by referring to FIG. 31. FIG. 31 shows the change of a monitor item in the performance measurement support function by detection of a change of a character string.

When an address complementary button is pressed on the employee registration screen, a part of the address is complementarily input. When the registration button is pressed, the information about the successful/unsuccessful registration is displayed in the status column as described above. When the address complementary button is pressed, the address column is monitored as a monitor item. When the registration button is pressed, the status column is monitored. Thus, a change of a character string can be detected.

Since the monitor item depends on the measurement target as described above, it is necessary to change the monitor item depending on the intention of a test operator or a user. In FIG. 31, a pop-up menu for customizing a test support is displayed by clicking the right button on the mouse for an optional point excluding an input field on the screen.

The pop-up menu contains items for changing a monitor item, changing a performance measuring method, that is, changing into a method used by invoking the above mentioned measurement completing method, and setting the upper limit of a measuring time described in step S62, thereby customizing the test support function.

Back in FIG. 30, if it is determined in step S55 that the target screen button has been pressed, then the measurement of the button processing time, that is, the elapsed time from when, for example, the registration button is pressed and the employee registration is performed until ‘registered’ is displayed in the status field, is started, and simultaneously the button process in the test target screen class 28 is invoked. In step S58, it is determined whether the method of measuring the button process time relates to detection of a change of a character string or invocation of a measuring method. If the method relates to the detection of a change of a character string, then it is determined in step S59 whether or not a change of a character string, etc. has been detected in an item specified, for example, in the above mentioned status item, etc. If no change is detected, then it is determined in step S60 whether or not a predetermined upper limit time has been exceeded. If not, then the processes in and after step S59 are repeated.

If the measuring method relates to the invocation of a measuring method, then it is determined in step S61 whether or not the measurement completing method has been invoked. If it has not been invoked yet, then it is determined in step S62 whether or not the upper limit time has been exceeded. If it has not been exceeded, then the processes in and after step S61 are repeated.

If a change has been detected in step S59, the upper limit time has been exceeded in steps S60 and S62, or it is determined that the measurement completing method has been invoked, then the processes in and after step S53 are repeated after the measurement is completed and the execution result information is written in step S63.

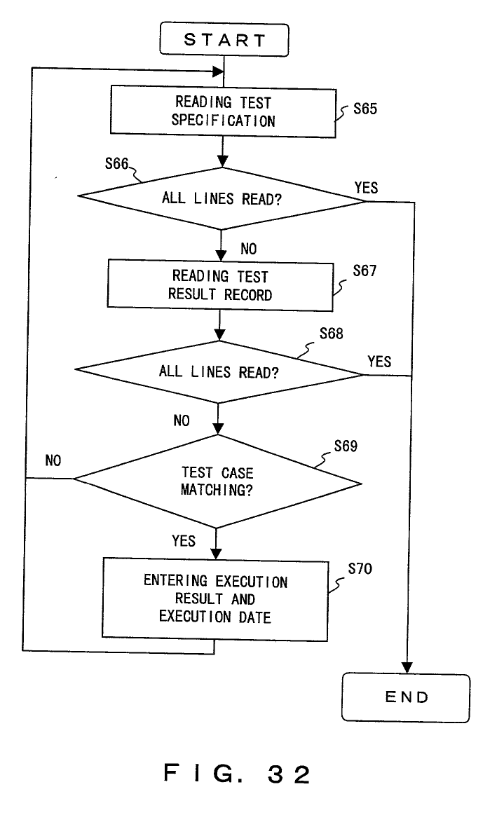

FIG. 32 is a flowchart of the process of the test report generation device. In FIG. 32, when the process starts, the test specifications are first read in step S65, and it is determined in step S66 whether or not all lines have been read. If yes, the process terminates immediately. If all lines have not been read yet, then the test result record of the test relating to a corresponding line is read in step S67. In step S68, it is determined in step S68 whether or not all lines of the test result record have been read. If they have been read, the process terminates immediately. If all lines have not been read yet, it is determined in step S69 whether or not the test cases match each other. If they do not match, then the processes in and after step S65 are repeated. If they match, the execution result and the execution date are input in step S70, and the processes in and after steps S65 are repeated.

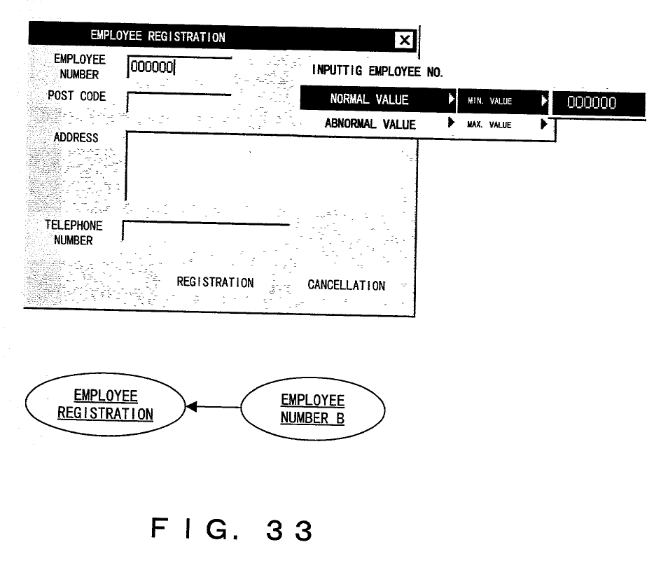

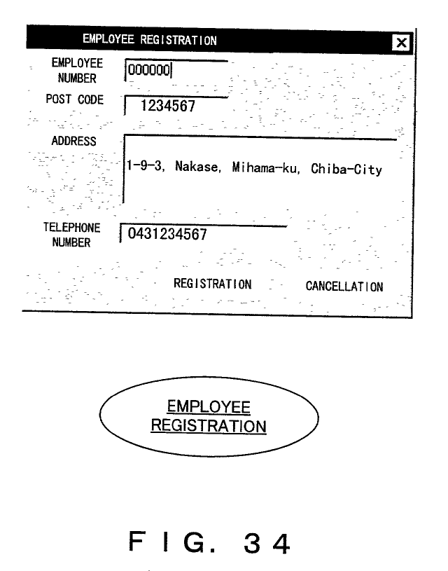

FIGS. 33 and 34 shows how the test support functions are separated in the test support apparatus according to the present invention. The test support functions have to be separated from one another after the test of the test target screen program is completed and before the program is actually used in an actual environment. FIG. 33 shows the display screen in a test execution environment, and a test is conducted on an employee registration screen class relating to inheritance by performing the test support B class.

On the other hand, FIG. 34 shows an example of a screen display in an actual environment. In the actual environment available in a program, only an employee registration class is performed.

Since data is added or amended in the source program of the employee registration screen in the conventional technology as shown in FIG. 17, it is necessary to nullify the addition or the amendments after the test is completed so that only the original functions can be maintained. Otherwise, a test mode and an actual mode are provided to change the mode of a process using an if sentence in a source program. With the configuration, there are a strong possibility that a mis-amendment or omission of amendments occurs. When a mode is changed, the test of the determination logic cannot be performed using a test driver. Therefore, a further test is required.

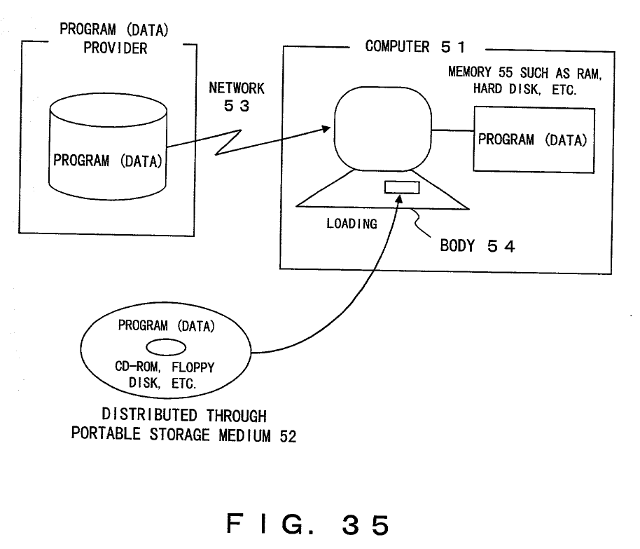

Finally, loading a program for realizing the present invention, that is, for supporting a test, on a computer is described below by referring to FIG. 35.

To realize the above mentioned embodiments of the present invention, it is necessary to generate the test support class 21 by the test support class generation device 20, to conduct a test using the test specification generated by the test specification generation device 16 and the test support class 21, and to generate a test report by the test report generation device 24. These operations can be performed by a common computer.

In 35, a computer 51 comprises a body 54 and memory 55. The memory 55 can be random access memory (RAM), a hard disk, a magnetic disk, etc. The memory stores a program for realizing the present invention, and the program is executed by the body 54, thereby realizing the test support apparatus of the present invention.

A program in the flowchart shown in FIGS. 19, 20, 22, 24, 26, 28, 30, and 32, etc. are stored in the memory 55, and the programs are executed by the body 54.

These programs can be loaded onto the computer 51 from a program provider through a network 53, marketed, distributed, and stored in a portable storage medium 52, and then executed after the portable storage medium is loaded onto the computer 51. The portable storage medium 52 can be various storage media such as a floppy disk, CD-ROM, an optical disk, an MO, etc.

The embodiments of the present invention have been described above. The features of the present invention can be summarized as follows. First, when a test specification is generated, the test specification itself is generated according to a screen definition information, or a test specification available as input test data is generated by conversion of a data format. Therefore, the test specification can be automatically generated, or can be easily generated although it contains a portion to be manually generated. As a result, documents can be easily prepared for guarantee of quality. Furthermore, since a specification can be generated according to screen definition information, a test pattern can cover a wide range, and can improve the reliability in consistency with the definition of the screen of input test data.

When a test is conducted, a test support function is added to a test target screen. Therefore, mis-input test data can be reduced, and a test execution result is recorded, thereby improving the reliability of the test. Furthermore, a testing work can be efficiently performed by automatic test execution and performance measurement support, and the passage portion in a screen program is indicated by the color of an input field on the screen, etc. when a test is conducted. Therefore, the test operator can easily grasp the status of the operation of the screen program.

Since the operation of a mouse cursor or a keyboard is not recorded, but input data and test results are recorded, a test can be conducted without amendments if it is conducted again after the position of a screen or the arrangement of the control is changed. Since no data is added to the screen program itself, the test support function can be easily removed after completing a test, and it is not necessary to amend a source program, the quality of the program after completing the test can be successfully guaranteed.

Furthermore, when a test report is generated, a test result can be automatically reflected on the test report. Therefore, a test operator can be prevented from mistakenly inputting data, thereby improving the reliability of the test report.

As described above in detail, the present invention can generate input data, support the input of the data, automatically conduct a test, record a rest result, and reflect the result on a test report, and can efficiently perform the 3-stage operation of generating a test specification, conducting a test, and reporting a test result. In addition, although the position of a test screen or the arrangement of the control is changed, the test support apparatus according to the present invention can effectively work, and can be used in conducting a test again after entering another OS.

Since it is not necessary to make amendments to the screen program to be tested, and the test support function can be easily removed after conducting a test, it is easy to enter an actual environment after completing the test, the quality of the program can be successfully guaranteed, and the reliability of the GUI system program can be improved.

While the invention has been described with reference to the preferred embodiments thereof, various modifications and changes may be made to those skilled in the art without departing from the true spirit and scope of the invention as defined by the claims thereof.

What is claimed is:

1. A test support apparatus for supporting a test of a screen program using a graphic user interface, comprising:
a test support class generation unit obtaining screen definition information about a test target screen program, and generating a test support class which is a subclass inheriting a class of the test target screen program according to the screen definition information, and a class for testing the test target screen program; and
a test execution unit conducting a test of the test target screen program using the generated test support class.

2. The apparatus according to claim 1, further comprising
a test specification generation unit generating a test specification for the test target screen program according to the screen definition information, and providing the test specification for said test execution unit.

3. The apparatus according to claim 2, further comprising:
a test report generation unit generating a test report using the test specification generated by said test specification generation unit and a test execution result obtained by said test execution unit.

4. The apparatus according to claim 3, wherein
said test support class has a function of supporting input of input test data.

5. The apparatus according to claim 1, wherein
said test support class has a function of recording a test result obtained when a test is conducted.

6. The apparatus according to claim 1, wherein
said test support class has a function of visually indicating a test execution portion on a screen.

7. The apparatus according to claim 1, wherein
said test support class has a function of conducting a test using new input test data or input data about a previous test execution result.

8. The apparatus according to claim 7, wherein
said test support class has a function of displaying a warning when an execution result of a test conducted using the input data about the previous test execution result is different from the previous test execution result.

9. The apparatus according to claim 1, wherein
said test support class has a function of supporting measurement of performance of the test target screen program.

10. A test supporting method for supporting a test of a screen program using a graphic user interface, comprising:
obtaining screen definition information about a test target screen program, and generating a test support class which is a subclass inheriting a class of the test target screen program according to the screen definition information, and a class for testing the test target screen program; and
conducting a test of the test target screen program using the generated test support class.

11. A computer-readable storage medium storing a program used to direct a computer to control support of a test of a screen program using a graphic user interface, said program to direct said computer to perform the process of:
obtaining screen definition information about a test target screen program; and
generating a test support class which is a subclass inheriting a class of the test target screen program according to the screen definition information, and a class for testing the test target screen program.

12. A computer-readable storage medium storing a program used to direct a computer to control support of a test of a screen program using a graphic user interface, said program to direct said computer to perform the process of:
receiving input data; and
conducting a test of a test target screen program using a test support class which is a subclass inheriting object-oriented programming for a class of the test target screen program, and tests a screen program using the received input data.

13. A computer data signal embodied in a carrier wave and representing a program that makes the computer perform the control for supporting a test of a screen program sing a graphic user interface, and the program makes the computer execute the process of:
receiving new input test data, or input data about a previous test execution result; and
conducting a test of a test target screen program using a test support class which is a subclass inheriting object-oriented programming for a class of the test target screen program, and tests a screen program using the received input data.

14. A test support apparatus for supporting a test of a screen program sing a graphic user interface, comprising:
test support class generation means for obtaining screen definition information about a test target screen program, and generating a test support class which is a subclass inheriting a class of the test target screen program according to the screen definition information, and a class for testing the test target screen program; and
test execution means for conducting a test of the test target screen program using the generated test support class.
